(19) United States
(12) Patent Application Publication
(10) Pub. No.: US 2026/0128304 A1
(43) Pub. Date: May 7, 2026

(54) HIGH-CAPACITY CATHODES CONTAINING SULFIDE COATINGS

(71) Applicant: BOARD OF TRUSTEES OF THE UNIVERSITY OF ARKANSAS, Little Rock, AR (US)

(72) Inventors: Xiangbo Meng, Fayetteville, AR (US); Meetesh Singh, Fayetteville, AR (US)

(73) Assignee: BOARD OF TRUSTEES OF THE UNIVERSITY OF ARKANSAS, Little Rock, AR (US)

(21) Appl. No.: 19/378,589

(22) Filed: Nov. 4, 2025

Related U.S. Application Data
(60) Provisional application No. 63/716,100, filed on Nov. 4, 2024.

(51) Int. Cl. H01M 4/58; H01M 4/02; H01M 4/131; H01M 4/36; H01M 4/505; H01M 4/62

(52) U.S. Cl. CPC H01M 4/5815; H01M 4/131; H01M 4/366; H01M 4/505; H01M 4/623; H01M 2004/028

(57) ABSTRACT

The invention relates to a cathode that includes a sulfide layer on a surface. The cathode surface may include a polymer layer and a metal oxide layer in an arrangement such that the sulfide layer is above the polymer layer, and the polymer layer is above the metal oxide layer. The invention also relates to energy storage devices that include the cathodes. The invention also relates to methods of making the cathodes by applying a composition onto a surface of the cathode to form a sulfide layer on the surface. The formed cathodes may be incorporated as a component of an energy storage device.

### CROSS-REFERENCE TO RELATED APPLICATIONS

This application claims priority to U.S. Provisional Patent Application No. 63/716,100, filed on Nov. 4, 2024. The entirety of the aforementioned application is incorporated herein by reference.

### BACKGROUND

A need exists for the development of cathodes and energy storage devices with enhanced electrochemical properties. Numerous embodiments of the present disclosure aim to address the aforementioned need.

### SUMMARY

In some embodiments, the present disclosure pertains to a cathode that includes a sulfide layer on a surface. In some embodiments, the cathode surface includes a polymer layer and a metal oxide layer. In some embodiments, the sulfide layer is above the polymer layer, and the polymer layer is above the metal oxide layer.

Additional embodiments of the present disclosure pertain to energy storage devices that include the cathodes of the present disclosure. In some embodiments, the energy storage devices of the present disclosure also include an anode and an electrolyte.

Further embodiments of the present disclosure pertain to methods of making the cathodes of the present disclosure by applying a composition onto a surface of the cathode to form a sulfide layer on the surface. In some embodiments, the application method is repeated multiple times to form multiple sulfide layers on the surface. In some embodiments, the application method occurs by atomic layer deposition (ALD). In some embodiments, the methods of the present disclosure also include a step of incorporating the cathode as a component of an energy storage device.

### BRIEF DESCRIPTION OF THE DRAWINGS

FIG. 1A provides an illustration of a cathode of the present disclosure.

FIG. 1B provides an illustration of an energy storage device of the present disclosure.

FIGS. 1C-1D illustrate methods of making a cathode of the present disclosure.

FIGS. 2A-2C provide scanning electron microscopy (SEM) images for the uncoated and Li₂S-coated 0.5Li₂MnO₃·0.5LiNi_{0.375}Mn_{0.375}Co_{0.25}O₂ (LMR-NMC) cathodes (i.e., B-LMR and Li₂S-LMR, respectively).

FIG. 2D provides an elemental mapping of the Li₂S-coated LMR-NMC.

FIGS. 3A-3D show electrochemical performance of B-LMR and Li₂S-LMR cathodes tested at 0.5 C (1 C=250 mAh/g) in the voltage window of 2.0-4.8 V. FIGS. 3A-3B show charge-discharge profiles of B-LMR (FIG. 3A) and Li₂S-LMR cathodes (FIG. 3B). FIGS. 3C-3D show cyclability (FIG. 3C) and Coulombic efficiency (FIG. 3D) of B-LMR and Li₂SLMR cathodes.

FIGS. 4A-4D show electrochemical performance of B-LMR and Li₂S-LMR cathodes tested at 0.5 C (1 C=250 mAh/g) in the voltage window of 2.0-4.9 V. FIGS. 4A-4B show charge-discharge profiles of B-LMR (FIG. 4A) and Li₂S-LMR cathodes (FIG. 4B). FIGS. 4C-4D show cyclability (FIG. 4C) and coulombic efficiency (FIG. 4D) of B-LMR and Li₂SLMR cathodes.

FIGS. 5A-5D show electrochemical performance of B-LMR and Li₂S-LMR cathodes tested at 0.5 C (1 C=250 mAh/g) in the voltage window of 2.0-4.7 V. FIGS. 5A-5B show charge-discharge profiles of B-LMR (FIG. 5A) and Li₂S-LMR cathodes (FIG. 5B). FIGS. 5C-5D show cyclability (FIG. 5C) and coulombic efficiency (FIG. 5D) of B-LMR and Li₂SLMR cathodes.

FIGS. 6A-6D show electrochemical performance of B-LMR, Li₂S-LMR, and Li₂S-P-LMR cathodes tested at 0.5 C (1 C=250 mAh/g) in the voltage window of 2.0-4.6 V. FIGS. 6A-6C show charge-discharge profiles of B-LMR (FIG. 6A), Li₂S-LMR (FIG. 6B), and Li₂S-P-LMR cathodes (FIG. 6C). FIG. 6D shows cyclability of B-LMR, Li₂S-LMR, and Li₂S-P-LMR cathodes.

FIG. 7 shows cyclability of B-LMR, Li₂S-P-LMR, and Li₂S-P-400-LMR cathodes tested at 0.5 C (1 C=250 mAh/g) in the voltage window of 2.0-4.7 V.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

A need exists for the development of cathodes and energy storage devices with enhanced electrochemical properties. In particular, rechargeable batteries now are a commodity of national and strategic significance, typically consisting of an anode, a cathode, and an electrolyte. Among commercialized rechargeable batteries, lithium-ion batteries (LIBs) could provide the highest energy density.

LIBs have secured their dominance in portable electronics (such as cell phones and laptops). With the ever-increasing desire to electrify transportation for mitigating the environmental issues and energy crises caused by fossil fuels, rechargeable batteries are expected to power electric vehicles (EVs). To this end, rechargeable batteries need to meet the following requirements: a high energy density of at least 300 Wh/kg for a driving range of at least 300 miles, an affordable cost of at least $125/kWh, reliable safety free of fires and explosions, and a long lifetime of at least 15 calendar years.

Unfortunately, state-of-the-art LIBs are still insufficient in all these aspects, including energy density, safety, cost, and lifetime. These facts have affected the market share of EVs. In this context, next-generation LIBs and lithium metal batteries (LMBs) are undergoing intensive investigations, which are expected to enable much higher energy densities.

In pursuing these new rechargeable batteries, cathode materials play a crucial role in the whole battery cell system, including working voltage, specific capacity, energy and power density, cycle life, and safety. Currently, the cathodes available for EVs are spinel LiMn₂O₄ (LMO), olivine LiFePO₄ (LFP), layered LiCoO₂ (LCO), layered LiNi_{0.8}Co_{0.15}Al_{0.05}O₂ (NCA), layered LiNiₓMn_{y}Co_{z}O₂ (NMCs, x+y+z=1), and layered Li and Mn rich (LMR) oxides, such as xLi₂MnO₃·(1−x)LiMO₂ (where M is 3 and/or 4d transition metals, such as Mn, Ni, Co, and Fe). Among all the available cathode materials, LMR cathodes are very attractive, ascribed to their high capacity (>250 mAh g−1) and high voltage (>4.5 V). Thus, LMR cathodes have the potential to achieve a high energy density of at least 1,000 Wh kg⁻¹.

Despite the tremendous benefits of LMR cathodes, several technical issues have hindered them from commercialization. Such issues have included (1) serious voltage decay, (2) significant capacity loss, (3) poor rate capability, and (4) low initial Coulombic efficiency (CE). Studies have revealed that these issues have their roots in structural instability, lattice oxygen release, and irreversible transition of transition metals (TMs, e.g., Mn, Co, and Ni) of LMR cathodes.

To address the aforementioned issues, different strategies have been investigated, such as surface engineering, surface coatings, elemental doping, composition optimization, structural engineering, and electrolyte additives. In spite of these efforts, LMR cathodes have not been commercialized and new solutions are urgently needed.

In sum, a need exists for the development of cathodes and energy storage devices with enhanced electrochemical properties. Numerous embodiments of the present disclosure aim to address the aforementioned need.

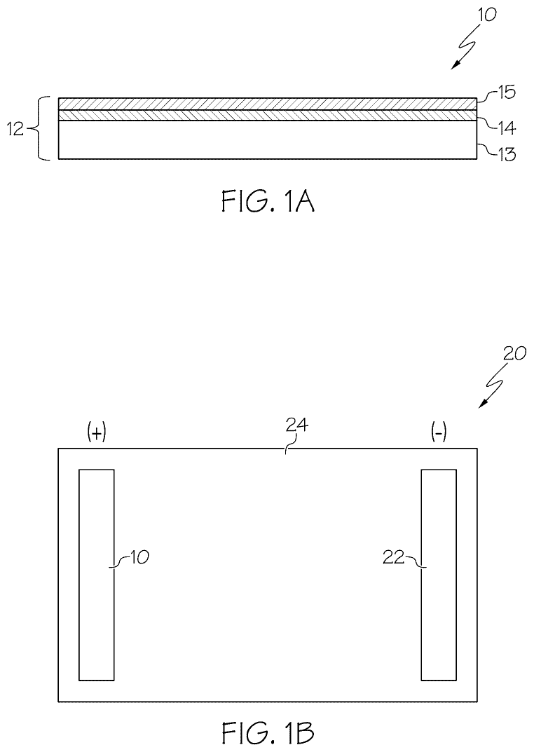

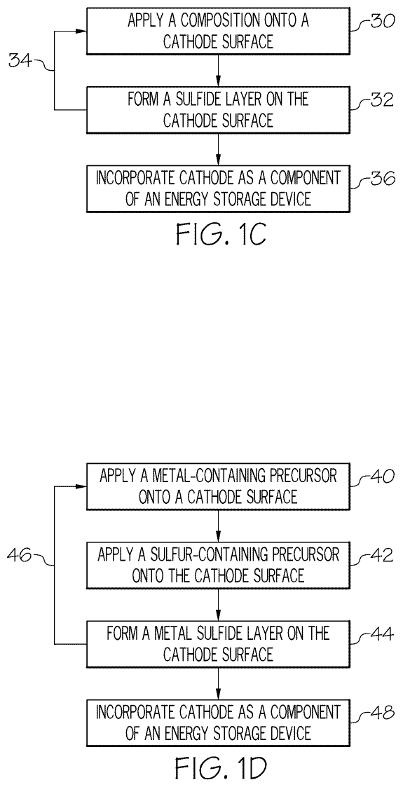

In some embodiments, the present disclosure pertains to a cathode that includes a sulfide layer on a surface. An example of a cathode of the present disclosure is illustrated in FIG. 1A as cathode 10. Cathode 10 includes surface 12 with a sulfide layer 15. In this example, cathode surface 12 includes a polymer layer 14 and a metal oxide layer 13, where sulfide layer 15 is above polymer layer 14, and where polymer layer 14 is above metal oxide layer 13.

Additional embodiments of the present disclosure pertain to energy storage devices that include the cathodes of the present disclosure. An example of an energy storage device of the present disclosure is illustrated in FIG. 1B as energy storage device 20. In this example, energy storage device 20 includes cathode 10, anode 22, and electrolyte 24.

Additional embodiments of the present disclosure pertain to methods of making the cathodes of the present disclosure. In some embodiments illustrated in FIG. 1C, such methods include: applying a composition onto a surface of the cathode (step 30) to form a sulfide layer on the surface (step 32). In some embodiments, the application method is repeated multiple times to form multiple sulfide layers on the surface (step 34). In some embodiments, the methods of the present disclosure also include a step of incorporating the cathode as a component of an energy storage device (step 36).

In some embodiments, the compositions of the present disclosure include metal sulfide precursors that are sequentially applied to the surface to form a metal sulfide layer on the surface. In some embodiments, the metal sulfide precursors include a metal-containing precursor and a sulfur-containing precursor. In some embodiments illustrated in FIG. 1D, such methods include: applying a metal-containing precursor onto a surface of the cathode (step 40), and applying a sulfur-containing precursor onto the surface of the cathode (step 42) to form a metal sulfide layer on the surface (step 44). In some embodiments, the application methods are repeated multiple times to form multiple metal sulfide layers on the surface (step 46). In some embodiments, the methods of the present disclosure also include a step of incorporating the cathode as a component of an energy storage device (step 48).

As set forth in more detail herein, the cathodes, energy storage devices and methods of the present disclosure can have numerous embodiments.

### Surfaces

The cathodes of the present disclosure can include various surfaces for association with sulfide layers. For instance, in some embodiments, the surface represents an outer surface of a cathode.

In some embodiments, a cathode surface includes a polymer layer (e.g., polymer layer 14 in FIG. 1A). In some of such embodiments, a sulfide layer is above the polymer layer (e.g., sulfide layer 15 in FIG. 1A). The surfaces of the present disclosure may include various polymer layers. For instance, in some embodiments, the polymer layer includes, without limitation, polyvinylidene fluoride (PVDF), polyaniline, polythiophene, polyfluorene, polyacrylonitriles, or combinations thereof.

In some embodiments, a cathode surface includes a metal oxide layer (e.g., a metal oxide layer 13 in FIG. 1A). In some of such embodiments, a sulfide layer (e.g., sulfide layer 15 in FIG. 1A) is above the metal oxide layer.

In some embodiments, a cathode surface includes a polymer layer (e.g., polymer layer 14 in FIG. 1A) and a metal oxide layer (e.g., a metal oxide layer 13 in FIG. 1A). In some of such embodiments, a sulfide layer (e.g., sulfide layer 15 in FIG. 1A) is above the polymer layer while the polymer layer is above the metal oxide layer.

The cathodes of the present disclosure can include various metal oxide layers. For instance, in some embodiments, the metal oxide layer includes, without limitation, a lithium (Li) oxide layer, an iron (Fe) oxide layer, a manganese (Mn) oxide layer, a cobalt (Co) oxide layer, a nickel (Ni) oxide layer, or combinations thereof. In some embodiments, the metal oxide layer includes, without limitation, LiFePO₄, Li- and Mn-based oxides, Li₂Mn₂O₄, LiMnO₂, Li₂MnO₃, LiCoO₂, LiNiO₂, LiNiₓCo_{y}Al_{z}O₂ (where x+y+z=1), LiNi_{0.8}Co_{0.15}Al_{0.05}O₂, LiNiₓMn_{y}Co_{z}O₂ (where x+y+z=1), LiNi_{0.375}Mn_{0.375}Co_{0.25}O₂, Li₂MnO₃·LiNiₓMn_{y}Co_{z}O₂ (where x+y+z=1), xLi₂MnO₃·(1−x)LiMO₂ (where M includes one or more 3d or 4d transition metals), 0.5Li₂MnO₃·0.5LiNi_{0.375}Mn_{0.375}Co_{0.25}O₂, or combinations thereof.

In some embodiments, the metal oxide layer includes Li- and Mn-based oxides. In some embodiments, the Li- and Mn-based oxides include, without limitation, Li₂Mn₂O₄, LiMnO₂, Li₂MnO₃, LiNiₓMn_{y}Co_{z}O₂ (where x+y+z=1), LiNi_{0.375}Mn_{0.375}Co_{0.25}O₂, Li₂MnO₃·LiNiₓMn_{y}Co_{z}O₂ (where x+y+z=1), xLi₂MnO₃·(1−x)LiMO₂ (where M includes one or more 3d or 4d transition metals), 0.5Li₂MnO₃·0.5LiNi_{0.375}Mn_{0.375}Co_{0.25}O₂, or combinations thereof.

### Sulfide Layers

The cathode surfaces of the present disclosure can include various sulfide layers. Additionally, the compositions of the present disclosure may be applied to various cathode surfaces to form various sulfide layers.

For instance, in some embodiments, the sulfide layer includes a metal sulfide. In some embodiments, the metal of the metal sulfide includes, without limitation, Li, Al, Zr, Zn, Ga, or combinations thereof. In some embodiments, the sulfide layer includes, without limitation, Li₂S, ZnS, Al₂S₃, Ga₂S₃, ZrS₂, or combinations thereof. In some embodiments, the sulfide layer includes Li₂S.

The sulfide layers of the present disclosure can include various numbers of layers. In some embodiments, the layers are in the form of stacked layers. In some embodiments, the sulfide layers include at least 10 layers. In some embodiments, the sulfide layers include at least 20 layers. In some embodiments, the sulfide layers include at least 50 layers. In some embodiments, the sulfide layers include at least 200 layers.

### Cathode Forms

The cathodes of the present disclosure may be in various forms. For instance, in some embodiments, the cathode includes a lithium manganese-rich (LMR) cathode.

### Energy Storage Devices

In some embodiments, the cathodes of the present disclosure are a component of an energy storage device. In some embodiments, the methods of the present disclosure also include a step of incorporating the cathodes of the present disclosure as a component of an energy storage device.

The cathodes of the present disclosure may serve as components of various energy storage devices. For instance, in some embodiments, the energy storage device includes a battery. In some embodiments, battery includes, without limitation, an alkali metal-based battery, a lithium-ion battery, a lithium metal battery, a solid-state battery, or combinations thereof. In some embodiments, the batteries of the present disclosure have a theoretical energy density of more than 1,000 Wh/kg.

In addition to cathodes, the energy storage devices of the present disclosure may include various additional components. For instance, in some embodiments, the energy storage devices of the present disclosure also include an anode (e.g., anode 22 in FIG. 1B). In some embodiments, the anode includes a lithium metal.

In some embodiments, the energy storage devices of the present disclosure also include a separator. In some embodiments, the separator includes a Celgard 2325 membrane.

In some embodiments, the energy storage devices of the present disclosure also include an electrolyte (e.g., electrolyte 24 in FIG. 1B). In some embodiments, the electrolyte includes, without limitation, LiPF₆, ethylene carbonate (EC), ethyl methyl carbonate (EMC), or combinations thereof. In some embodiments, the electrolyte includes LiPF6 in ethylene carbonate (EC) and ethylmethyl carbonate (EMC) at an EC: EMC ratio of 3:7.

### Application of Compositions to Cathode Surfaces

The methods of the present disclosure may apply various compositions to cathode surfaces to form sulfide layers on the surfaces. For instance, in some embodiments, the composition includes a metal sulfide. In some embodiments, the metal sulfide includes, without limitation, Li₂S, ZnS, Al₂S₃, Ga₂S₃, ZrS₂, or combinations thereof.

In some embodiments, the compositions of the present disclosure include metal sulfide precursors that are sequentially applied to a cathode surface to form a metal sulfide layer on the surface. In some embodiments, the metal sulfide precursors include at least one metal-containing precursor and at least one sulfur-containing precursor.

In some embodiments, the metal-containing precursors and sulfur-containing precursors are applied onto a surface at the same time to form a metal sulfide layer on the surface. In some embodiments, the metal-containing precursors and sulfur-containing precursors are applied onto a surface sequentially to form a metal sulfide layer on the surface. For instance, in some embodiments, the application steps include applying a metal-containing precursor to the cathode surface and then applying a sulfur-containing precursor onto the surface to form the metal sulfide layer. In some embodiments, the application steps include applying a sulfur-containing precursor to the cathode surface and then applying a metal-containing precursor onto the surface to form the metal sulfide layer.

The compositions of the present disclosure can include various sulfur-containing precursors. For instance, in some embodiments, the sulfur-containing precursors include, without limitation, H₂S, di-tert-butyl disulfide (TBDS), or combinations thereof.

The compositions of the present disclosure can also include various metal-containing precursors. For instance, in some embodiments, the metal-containing precursors include one or more metals. In some embodiments, the metals include, without limitation, Li, Al, Zr, Zn, Ga, or combinations thereof.

In some embodiments, the metal-containing precursors include lithium-containing precursors. In some embodiments, the lithium-containing precursors include, without limitation, lithium tert-butoxide (LTB, LiO^{t}Bu), lithium hexamethyldisilazide (LiHMDS, Li(N(SiMe₃)₂), lithium trimethylsilanolate (LiTMSO, LiOSiMe₃), Li(2,2,6,6-tetramethyl-3,5-heptanedionate) (Li(thd)), or combinations thereof.

In some embodiments, the metal-containing precursors include aluminum-containing precursors, such as tris(dimethylamido)aluminum (TDMA-Al). In some embodiments, the metal-containing precursors include zinc-containing precursors, such as prediethylzinc (DEZ). In some embodiments, the metal-containing precursors include zirconium-containing precursors, such as tetraki(dimethylamido)zirconium (TDMA-Zr). In some embodiments, the metal-containing precursors include gallium-containing precursors, such as tris(dimethylamido)gallium (TDMA-Ga).

The compositions of the present disclosure may be applied to cathode surfaces in various manners. For instance, in some embodiments, the compositions of the present disclosure are applied through a method that includes, without limitation, molecular layer deposition (MLD), atomic layer deposition (ALD), or combinations thereof. In some embodiments, the composition is applied through atomic layer deposition (ALD).

In some embodiments, the compositions of the present disclosure may be applied multiple times onto a cathode surface such that multiple sulfide layers are formed on the surface. For instance, in some embodiments, the application is repeated at least 10 times to form at least 10 sulfide layers on the surface. In some embodiments, the application is repeated at least 20 times to form at least 20 sulfide layers on the surface. In some embodiments, the application is repeated at least 50 times to form at least 50 sulfide layers on the surface. In some embodiments, the application is repeated at least 200 times to form at least 200 sulfide layers on the surface.

### Additional Embodiments

Reference will now be made to more specific embodiments of the present disclosure and experimental results that provide support for such embodiments. However, Applicant notes that the disclosure below is for illustrative purposes only and is not intended to limit the scope of the claimed subject matter in any way.

### Example 1. Tackling Interfacial and Structural Issues of Lithium-Rich High-Capacity Cathodes by Sulfide Coatings

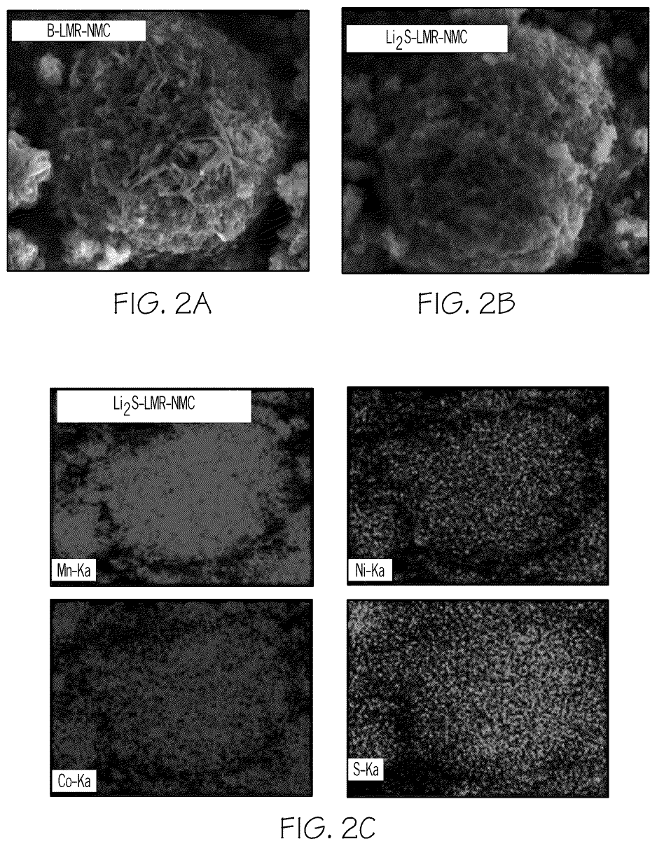

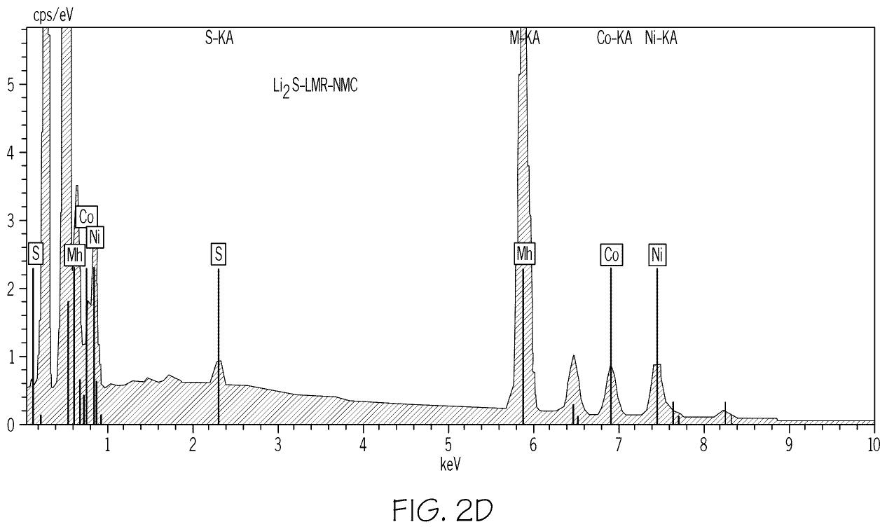

In this Example, Applicant demonstrates that sulfides can be an important class of coating materials for various cathodes, especially lithium manganese-rich (LMR) cathodes. Applicant demonstrated this discovery using lithium sulfide (Li₂S) in this Example. The Li₂S coating was deposited on an LMR cathode powder, 0.5Li₂MnO₃·0.5LiNi_{0.375}Mn_{0.375}Co_{0.25}O₂ (LMR-NMC), and prefabricated LMR-NMC electrodes, using a thin film technique of atomic layer deposition (ALD). The resultant Li₂S-coated LMR-NMC powders were fabricated into electrodes (Li₂S-P-LMR) and also were further annealed at 400° C. for 5 hours with a temperature increment rate of 5° C./min. The resulting annealed powders were further fabricated into electrodes (Li₂S-P-400-LMR). Compared to bare LMR-NMC electrodes (B-LMR, FIG. 2A), the resultant three different ALD-coated LMR electrodes (i.e., Li₂S-LMR, Li₂S-P-LMR, and Li₂S-P-400-LMR) all exhibited evident improvements in their electrochemical performance and morphology (FIGS. 2B-2D, 3A-3D, 4A-4D, 5A-5D, 6A-6D, and 7).

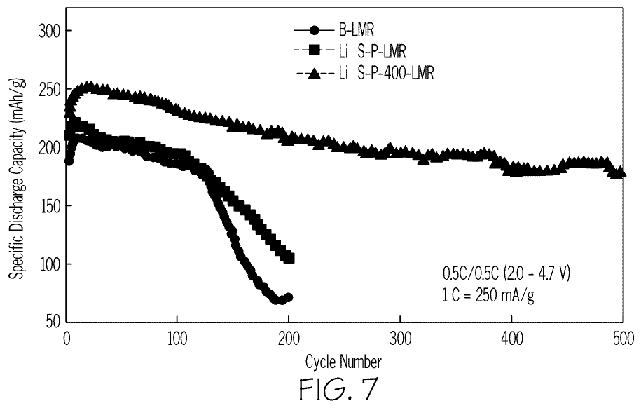

In comparison, the performance of the Li₂S-P-400-LMR cathodes is particularly impressive, showing the best improvements in capacity retention and long-term cyclability (FIG. 7). The Li₂S coating was verified for beneficial effects in three aspects: (1) improve the mechanical integrity of all these LMR electrodes and LMR powders themselves; (2) reconstruct and stabilize the interface between the LMR electrodes and their electrolyte; (3) mitigate the irreversible structural phase transition of LMR-NMC materials; (4) remove oxygen released from LMR-NMC lattices, and (5) protect the electrolyte from oxidation.

Not limited to Li₂S, this Example covers any sulfides that can be used as coating materials to improve the performance LMR cathodes. Furthermore, this Example is not limited to LMR cathodes. This Example potentially is effective for other cathodes materials, such as olivine LiFePO₄, spinel Li₂Mn₂O₄, layered LiCoO₂, layered LiNiO₂, and layered LiMnO₂. This Example also includes LMR electrode fabrication, ALD coating of Li₂S, and electrochemical evaluation of LMR cathodes.

### Example 1.1. Electrode Preparation

The LMR electrode laminates in this Example contain 80 wt. % 0.5Li₂MnO₃·0.5LiNi_{0.375}Mn_{0.375}Co_{0.25}O₂ (LMR-NMC) powder, 10 wt. % polyvinylidene fluoride (PVDF), and 10 wt. % carbon black. To fabricate the laminates, a slurry was first prepared by mixing LMR-NMC powders, PVDF, and carbon black with a suitable amount of 1-Methyl-2-pyrrolidinone (NMP) homogenously. Then, the slurry was coated on Al foils. The resultant LMR laminates were fully dried in air first and then in vacuum at 100° C. for 10 hrs. The mass loading of the prepared LMR electrodes is ˜7.0 mg/cm².

### Example 1.2. Li₂S ALD Coatings

In this Example, the Li₂S coating was deposited on LMR laminates at 150° C. using an atomic layer deposition (ALD) system (i.e., Savannah 200, Cambridge Nanotech Inc., USA) integrated with an Ar-filled glove box. This integrated ALD-glove box facility guaranteed no air-exposure to the Li₂S-coated NMC811 laminates.

The Li₂S ALD proceeded using lithium tert-butoxide (LTB, 98 at. %, Strem Chemicals, Inc.) and hydrogen sulfide (H₂S, 4 at. % in Argon, Airgas) as precursors. Ar was used as the carrier gas of the ALD precursors. To provide sufficient vapor pressure, the solid LTB was heated to 150 ° C. in a stainless steel bubbler. A single ALD cycle was performed with four successive steps: (1) a 3.0 s dose of LTB; (2) a 10.0 s purge using Ar gas to remove excessive LTB and byproducts; (3) a 0.5 s dose of H₂S, and (4) a 10.0 s purge using Ar gas to remove excessive H₂S and byproducts. LMR electrodes were coated with 20 ALD cycles. The growth per cycle of the ALD Li₂S was ˜1.1 Å.cycle-1. Thus, the coating thickness was ˜2 nm. To facilitate identifying the different coated electrodes, the resultant ALD-coated electrodes were denoted as Li₂S-LMR. Accordingly, the bare (uncoated) LMR electrode was signified as B-LMR.

The Li₂S coating also was applied on LMR-NMC powders for 20 ALD cycles at the same experimental conditions described above. The resultant Li₂S-coated LMR powders were further fabricated into electrodes denoted as Li₂S-P-LMR. The Li₂S-coated LMR powders also were annealed in Ar at 400° C. for 5 hours with a temperature increment rate of 5° C./min and then the received annealed powders were made into electrodes denoted as Li₂S-P-400-LMR.

### Example 1.3. Materials Characterization

LMR electrodes were observed for morphological characteristics and element distribution, using a scanning electron microscopy (SEM) equipped with an energy dispersive X-ray spectroscopy (EDX). The images are shown in FIGS. 2A-2C.

### Example 1.4. Electrochemical Measurements

Coin cells were assembled in the Ar-filled glove box after the different electrodes (B-LMR, Li₂S-LMR, Li₂S-P-LMR, and Li₂S-P-400-LMR) were prepared. In the glove box, oxygen and water were controlled less than 0.01 ppm. Li metal and Celgard 2325 membrane were used as the anode and the separator, respectively. The electrolyte was composed of 1.2 M LiPF₆ in ethylene carbonate (EC)/ethylmethyl carbonate (EMC) (3:7 by weight Panax Etec Co.).

All the assembled cells were rested for 10 hours prior to their electrochemical tests at room temperature. Galvanostatic charge-discharge was carried out using a Neware battery test system. The cells were cycled at 0.5 C (1 C=250 mA/g) under constant current (CC) mode in the voltage ranges of 2.0-4.6/4.7/4.8/4.9 V versus Li/Li+.

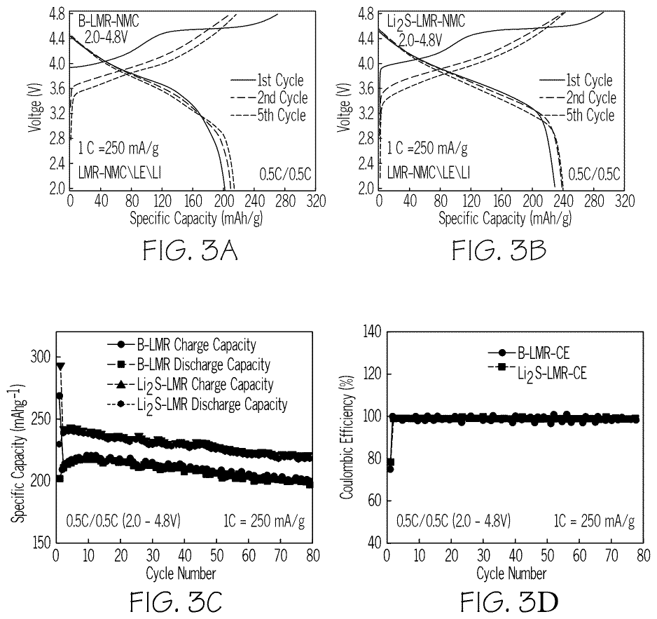

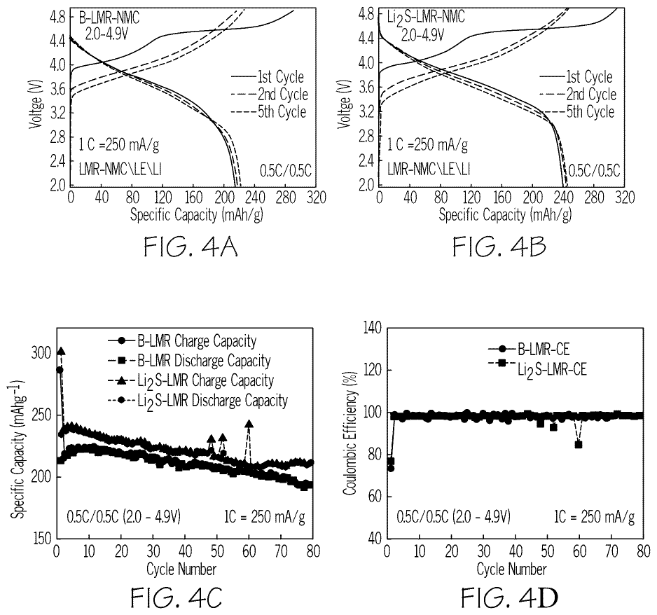

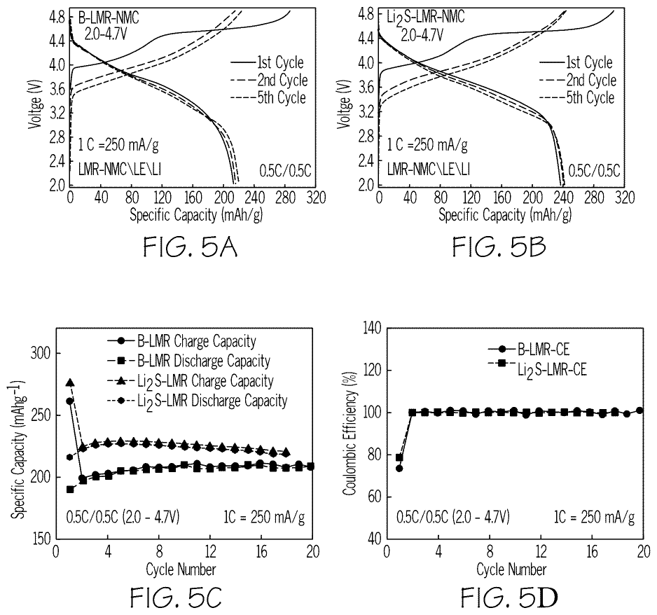

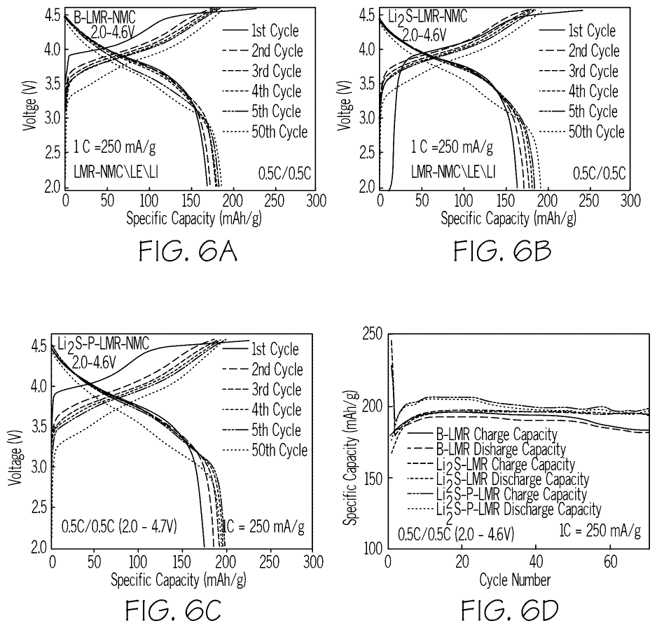

The effects of the ALD Li₂S coatings on LMR cathodes were electrochemically investigated, as shown in FIGS. 3A-3D, 4A-4D, 5A-5D, 6A-6D, and 7. As shown in FIGS. 3A-3D, 4A-4D, 5A-5D, and 6A-6D, Li₂S-LMR cathodes exhibited better cyclability and higher sustainable capacity in four voltage windows of 2.0-4.6 V (FIGS. 6A-6D), 2.0-4.7 V (FIGS. 5A-5D), 2.0-4.8 V (FIGS. 3A-3D), and 2.0-4.9 V (FIGS. 4A-4D), tested at 0.5 C (1 C=250 mA/g) for both charge and discharge. These results clearly demonstrated that the 20-cycle ALD Li₂S coating is effective to improve the performance of Li₂S-LMR electrodes. Observing charge-discharge profiles in FIGS. 3A-3D, 4A-4D, 5A-5D, and 6A-6D, there were no evident difference generated by the ALD Li₂S coating. This implies that these ALD-coated electrodes themselves were not changed for their chemistry.

Furthermore, Applicant comparatively investigated the performance of B-LMR, Li₂S-LMR, and Li₂S-P-LMR cathodes. In terms of sustainable capacity, as shown in FIGS. 6A-6D, Li₂S-P-LMR performed the best and was followed by Li₂S-LMR and B-LMR.

Applicant further comparatively investigated the performance of B-LMR, Li₂S-P-LMR, and Li₂S-P-400-LMR cathodes. In terms of sustainable capacity, as shown in FIG. 7, Li₂S-P-400-LMR performed the best and was followed by Li₂S-P-LMR and B-LMR. Particularly, the Li₂S-P-400-LMR cathode could achieve 500 charge-discharge cycles while still sustaining a high capacity, ˜180 mAh/g, accounting for a ˜80% capacity retention. In comparison, the B-LMR and Li₂S-P-LMR cathodes failed in 200 charge-discharge cycles.

### Example 1.5. Summary

To summarize, the ALD Li₂S coating has clearly demonstrated significant effects on improving the performance of LMR cathodes. The beneficial effects lie in multiple aspects, including improved mechanical integrity of electrodes, reduced microcracking, reduced side reactions, and mitigated phase transitions. This Li₂S coating represents the first effort using sulfides as coatings for LMR cathodes. Potentially, any sulfides potentially are beneficial to LMR cathodes as well as other LIB cathodes.

The performance of Li₂S-P-400-LMR cathodes were observed under different parameters, including different voltage windows and current densities. Not limited to Li₂S, additional sulfides may also be utilized (e.g., ZnS, Al₂S₃, Ga₂S₃, and ZrS₂) for improved performance of LMR cathodes.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

1. A cathode comprising:
a surface; and
a sulfide layer on the surface.

2. The cathode of claim 1, wherein the surface comprises a metal oxide layer, and wherein the sulfide layer is above the metal oxide layer.

3. The cathode of claim 2, wherein the metal oxide layer is selected from the group consisting of a lithium (Li) oxide layer, an iron (Fe) oxide layer, a manganese (Mn) oxide layer, a cobalt (Co) oxide layer, a nickel (Ni) oxide layer, LiFePO₄, Li- and Mn-based oxides, Li₂Mn₂O₄, LiMnO₂, Li₂MnO₃, LiCoO₂, LiNiO₂, LiNiₓCo_{y}Al_{z}O₂ (where x+y+z=1), LiNi_{0.8}Co_{0.15}Al_{0.05}O₂, LiNiₓMn_{y}Co_{z}O₂ (where x+y+z=1), LiNi_{0.375}Mn_{0.375}Co_{0.25}O₂, Li₂MnO₃·LiNiₓMn_{y}Co_{z}O₂ (where x+y+z=1), xLi₂MnO₃·(1−x)LiMO₂ (where M comprises one or more 3d or 4d transition metals), 0.5Li₂MnO₃·0.5LiNi_{0.375}Mn_{0.375}Co_{0.25}O₂, or combinations thereof.

4. The cathode of claim 2, wherein the metal oxide layer comprises Li- and Mn-based oxides.

5. The cathode of claim 2, wherein the Li- and Mn-based oxides are selected from the group consisting of Li₂Mn₂O₄, LiMnO₂, Li₂MnO₃, LiNiₓMn_{y}Co_{z}O₂ (where x+y+z=1), LiNi_{0.375}Mn_{0.375}Co_{0.25}O₂, Li₂MnO₃·LiNiₓMn_{y}Co_{z}O₂ (where x+y+z=1), xLi₂MnO₃·(1−x)LiMO₂ (where M comprises one or more 3d or 4d transition metals), 0.5Li₂MnO₃·0.5LiNi_{0.375}Mn_{0.375}Co_{0.25}O₂, or combinations thereof.

6. The cathode of claim 1, wherein the surface comprises a polymer layer and a metal oxide layer, wherein the sulfide layer is above the polymer layer, and wherein the polymer layer is above the metal oxide layer.

7. The cathode of claim 1, wherein the sulfide layer comprises a metal sulfide.

8. The cathode of claim 1, wherein the sulfide layer is selected from the group consisting of Li₂S, ZnS, Al₂S₃, Ga₂S₃, ZrS₂, or combinations thereof.

9. The cathode of claim 1, wherein the sulfide layer comprises Li₂S.

10. An energy storage device comprising a cathode, wherein the cathode comprises:
a surface; and
a sulfide layer on the surface.

11. The energy storage device of claim 10, wherein the energy storage device comprises a battery.

12. The energy storage device of claim 11, wherein battery is selected from the group consisting of an alkali metal-based battery, a lithium-ion battery, a lithium metal battery, a solid-state battery, or combinations thereof.

13. The energy storage device of claim 10, wherein the surface comprises a metal oxide layer, and wherein the sulfide layer is above the metal oxide layer.

14. The energy storage device of claim 13, wherein the metal oxide layer is selected from the group consisting of a lithium (Li) oxide layer, an iron (Fe) oxide layer, a manganese (Mn) oxide layer, a cobalt (Co) oxide layer, a nickel (Ni) oxide layer, LiFePO₄, Li- and Mn-based oxides, Li₂Mn₂O₄, LiMnO₂, Li₂MnO₃, LiCoO₂, LiNiO₂, LiNiₓCo_{y}Al_{z}O₂ (where x+y+z=1), LiNi_{0.8}Co_{0.15}Al_{0.05}O₂, LiNiₓMn_{y}Co_{z}O₂ (where x+y+z=1), LiNi_{0.375}Mn_{0.375}Co_{0.25}O₂, Li₂MnO₃·LiNiₓMn_{y}Co_{z}O₂ (where x+y+z=1), xLi₂MnO₃·(1−x)LiMO₂ (where M comprises one or more 3d or 4d transition metals), 0.5Li₂MnO₃·0.5LiNi_{0.375}Mn_{0.375}Co_{0.25}O₂, or combinations thereof.

15. The energy storage device of claim 13, wherein the metal oxide layer comprises Li- and Mn-based oxides.

16. The energy storage device of claim 15, wherein the Li- and Mn-based oxides are selected from the group consisting of Li₂Mn₂O₄, LiMnO₂, Li₂MnO₃, LiNiₓMn_{y}Co_{z}O₂ (where x+y+z=1), LiNi_{0.375}Mn_{0.375}Co_{0.25}O₂, Li₂MnO₃·LiNiₓMn_{y}Co_{z}O₂ (where x+y+z=1), xLi₂MnO₃·(1−x)LiMO₂ (where M comprises one or more 3d or 4d transition metals), 0.5Li₂MnO₃·0.5LiNi_{0.375}Mn_{0.375}Co_{0.25}O₂, or combinations thereof.

17. The energy storage device of claim 10, wherein the surface comprises a polymer layer and a metal oxide layer, wherein the sulfide layer is above the polymer layer, and wherein the polymer layer is above the metal oxide layer.

18. The energy storage device of claim 10, wherein the sulfide layer comprises a metal sulfide.

19. The energy storage device of claim 10, wherein the sulfide layer is selected from the group consisting of Li₂S, ZnS, Al₂S₃, Ga₂S₃, ZrS₂, or combinations thereof.

20. The energy storage device of claim 10, wherein the sulfide layer comprises Li₂S.

21. A method of making a cathode, said method comprising:
applying a composition onto a surface of the cathode to form a sulfide layer on the surface.

22. The method of claim 21, wherein the sulfide layer comprises a metal sulfide selected from the group consisting of Li₂S, ZnS, Al₂S₃, Ga₂S₃, ZrS₂, or combinations thereof.

23. The method of claim 21, wherein the application is repeated at least 10 times to form at least 10 sulfide layers on the surface.

24. The method of claim 21, wherein the composition comprises a metal sulfide.

25. The method of claim 21, wherein the composition comprises metal sulfide precursors that are sequentially applied to the surface to form a metal sulfide layer on the surface, wherein the metal sulfide precursors comprise at least one metal-containing precursor and at least one sulfur-containing precursor, and wherein the applying comprises:
applying the metal-containing precursor to the to the surface; and
applying the sulfur-containing precursor to the surface.

26. The method of claim 25, wherein the sulfur-containing precursor is selected from the group consisting of H₂S, di-tert-butyl disulfide (TBDS), or combinations thereof.

27. The method of claim 25, wherein the metal-containing precursor comprises one or more metals selected from the group consisting of Li, Al, Zr, Zn, Ga, or combinations thereof.

28. The method of claim 25, wherein the metal-containing precursor comprises a lithium-containing precursor selected from the group consisting of lithium tert-butoxide (LTB, LiO^{t}Bu), lithium hexamethyldisilazide (LiHMDS, Li(N(SiMe₃)₂), lithium trimethylsilanolate (LiTMSO, LiOSiMe₃), Li(2,2,6,6-tetramethyl-3,5-heptanedionate) (Li(thd)), or combinations thereof.

29. The method of claim 25, wherein the composition is applied through atomic layer deposition (ALD).

30. The method of claim 21, wherein the surface comprises a metal oxide layer, and wherein the sulfide layer is formed above the metal oxide layer.

31. The method of claim 30, wherein the metal oxide layer is selected from the group consisting of a lithium (Li) oxide layer, an iron (Fe) oxide layer, a manganese (Mn) oxide layer, a cobalt (Co) oxide layer, a nickel (Ni) oxide layer, LiFePO₄, Li₂Mn₂O₄, LiMnO₂, Li₂MnO₃, LiCoO₂, LiNiO₂, Li- and Mn-based oxides, LiNiₓCo_{y}Al_{z}O₂ (where x+y+z=1), LiNi_{0.8}Co_{0.15}Al_{0.05}O₂, LiNiₓMn_{y}Co_{z}O₂ (where x+y+z=1), LiNi_{0.375}Mn_{0.375}Co_{0.25}O₂, Li₂MnO₃·LiNiₓMn_{y}Co_{z}O₂ (where x+y+z=1), xLi₂MnO₃·(1−x)LiMO₂ (where M comprises one or more 3d or 4d transition metals), 0.5Li₂MnO₃·0.5LiNi_{0.375}Mn_{0.375}Co_{0.25}O₂, or combinations thereof.
